(19) United States
(12) Patent Application Publication
(10) Pub. No.: US 2007/0191059 A1
(43) Pub. Date: Aug. 16, 2007

(54) Mobile telecommunication unit configurable to connect to a supplementary module

(75) Inventors: Yuen Khim Joseph Liow, Singapore (SG); Slang Thia Goh, Singapore (SG); Angela Jean, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd

(21) Appl. No.: 11/355,835

(22) Filed: Feb. 15, 2006

(51) Int. Cl. H04B 1/38

(52) U.S. Cl. 455/558

(57) ABSTRACT

A mobile telephone unit has a cavity for receiving a supplementary module, which is enabled to store and decompress media data files, especially audio data files in the MP3 format. The mobile telephone unit includes a data transfer port for connection directly to a corresponding data transfer port of the supplementary module, so that the mobile telephone unit can functionally interact with the supplementary module, to transfer data to the mobile telephone unit and/or from the mobile telephone.

### FIELD OF THE INVENTION

The present invention relates to a mobile telephone unit which can be coupled to a supplementary module, where the supplementary module is capable of performing one or more of a variety of functions.

### BACKGROUND OF INVENTION

Mobile telephone units are manufactured with a number of built-in functions. Some of these are essential for the operation of the unit, such as the ability to establish a wireless communication path with a telephone service provider. Others are essentially optional, such as the ability to receive and implement new ring tones. Although the functions available in different mobile telephone units are diverse, the functions available within any given mobile telephone are limited to those envisaged by the manufacturer. Furthermore, the data available within the mobile telephone unit (e.g. the set of ring tones) is generally limited to data pre-stored by the manufacturer, plus any additional data which the mobile telephone unit has downloaded from the communication network and/or into a socket of the mobile telephone unit.

### SUMMARY OF THE INVENTION

The present invention aims to provide a new and useful mobile telephone unit.

In general terms, the present invention proposes that a mobile telephone unit includes a removable supplementary module, which performs a function such as storing and decompressing audio data files, such as audio data files in the MP3 format. The mobile telephone unit includes a data transfer port for connection directly (e.g. without an intervening cable) to a corresponding data transfer port of the supplementary module, so that the mobile telephone unit can functionally interact with the supplementary module, to transfer data to the mobile telephone unit and/or to the supplementary module.

The mobile telephone-supplementary module combination may thus have the combined functionality of a mobile telephone and a music player. Furthermore, the interaction of the two units presents possibilities for synergistic interaction of the units.

For example, the mobile telephone may be configured to transmit data received from the supplementary module out of the telephone to a telecommunications network, and/or to receive data (such as compressed music files) from the telecommunications network and pass it on to the supplementary module.

Note that although the supplementary module is operative to store files in the MP3 format, it is typically not limited in this respect. Rather, it may be operative to store data files in any other format, and to transmit them and/or receive them using its data transfer port.

Similarly, although the supplementary module is preferably configured to receive MP3 files from the communication network via the mobile telephone, and/or to transmit them to the communication network via the mobile telephone, the supplementary module may be operative to transmit data to the mobile telephone in any format, or indeed in a selected one of a plurality of formats.

For example, the supplementary module may be able to transmit data to the mobile telephone unit through the data communication port in an uncompressed form (e.g. an analogue form) which drives a sound generation device located in the mobile telephone unit, such as a loudspeaker or a head-telephone socket. Alternatively or additionally, the supplementary module may be operative to generate a decompressed audio signal which is transmitted out of the supplementary module other than via its communication port, e.g. through a headphone socket provided in the supplementary module.

When the supplementary module is connected to the mobile telephone unit, the supplementary module may be operative to receive electrical power from the mobile telephone unit, and to use the power to perform its functions.

The data transfer ports of the mobile telephone unit and supplementary module are typically standard USB ports (typically series A ports) or IEEE 1394 ports. Typically, the communication port of the mobile telephone unit is a socket-type port, while the supplementary module includes the corresponding plug-type port, for insertion into the socket.

This form of supplementary module may, in fact, be equivalent to any of the memory modules described in WO 03/085670, the disclosure of which is incorporated here by reference. This discloses a mobile memory module having a housing which includes an integral connector port, which is typically a USB plug or an IEEE1394 plug. The plug of the memory module can be inserted into the socket of a computer (or the like) to receive data (e.g. audio data), or alternatively to transmit audio data to the computer to allow the audio date to be broadcast through a loudspeaker of the computer. The plug can alternatively be inserted into a socket provided in a battery pack. In this configuration, the battery pack transmits power through the plug to power the memory module. In one embodiment, the memory module is operative to transmit an audio signal though a headphone socket provided in its housing, to headphones worn by the user. Such a device is distributed by Creative Technology Ltd. of Singapore, and referred to as the Muvo TX NX USB. Such a device is shown in FIG. 8. A media player module 202 is received by a cradle 200 including a battery. This series of MP3 players is currently only able to playback digital music files. The shaped cradle 200 is a source of power for a media player module 202, but there is no option of replacing the shaped cradle 200 with a different sort of cradle to provide different functionalities, such as that of a mobile phone.

In the context of this form of the present invention, this memory module is used in combination with a mobile telephone designed to couple to it directly. At other times, as in the prior art, the memory module may optionally be used in combination with a battery pack.

Note that, within the scope of the present invention, the supplementary module configured to interact with the mobile telephone may be replaced by another supplementary module having different properties, such as a different data storage capacity and/or a different data transfer rate through the communication port and/or different data stored within it. Thus, the mobile telephone-supplementary module combination can be up-graded.

Furthermore, the supplementary module may optionally be replaced by a further functional module, which may optionally be sold in combination with the mobile telephone unit and supplementary module. Thus, the functionality of the mobile telephone-supplementary module combination can be changed by disconnecting the supplementary module and connecting the functional module in its place. There are several possibilities for what the functional module may be. In one possibility, the functional unit may itself be a wireless communication module, in particular one which is operative to communicate as part of a WLAN network. The functional unit may for example, be a wi-fi module. By this is meant a device which is capable of communication with other equipment by means of the 802.11 family of specifications, such as 802.11b. Thus, when the supplementary module is replaced by a wi-fi module, the mobile telephone is enabled to communicate with wi-fi devices, instead of to access the memory of the supplementary module. Typically, the mobile telephone unit includes a cavity for receiving the supplementary module (or other functional module). Typically, the cavity includes the data port of the mobile telephone unit, facing into the cavity. The cavity is typically a slot on one side of the housing of the mobile telephone unit.

The form factor of the supplementary module typically is such that, when it is configured in combination with the mobile telephone unit, the combination forms a body having a generally cuboidal configuration.

The overall form factor of the combination is typically not very much greater proportionally than that of the mobile telephone alone. For example, it may be such that the smallest cuboid which can be defined containing the combination is not much greater in volume (e.g. only 10% greater or only 20% greater) than the smallest cuboid which can be defined containing the mobile telephone unit alone. Typically, the two cuboids are rather similar to each other, and have respective sides which are substantially parallel.

Optionally, the mobile telephone unit may be provided with a separate “place holder” unit, which can be inserted into the cavity when no supplementary module is provided. The place holder may, for example, be a cover for protecting the sockets of the mobile telephone unit. The form-factor of the place holder may optionally be selected to give the mobile telephone unit-place holder combination a convenient form-factor, such as a generally cuboidal configuration.

The invention may be expressed as a mobile phone unit which is a combination of a mobile phone and a supplementary module. However, it may also be understood as including either of the mobile phone and supplementary individually, when designed to be operable with the other.

### BRIEF DESCRIPTION OF THE FIGURES

An embodiment of the invention will now be described for the sake of illustration only, with reference to the following figures in which:

FIG. 1 is a first perspective view of a first embodiment of the invention, showing a combination of a mobile telephone and supplementary module, at a time when the supplementary module is being inserted into a cavity of the mobile telephone;

FIG. 2 is a second front perspective view of the embodiment of FIG. 1, in an assembled configuration;

FIG. 3 is a third perspective view of the embodiment of FIG. 1, in the configuration of FIG. 2 but viewed from another direction;

FIG. 4 is a block diagram of the combination of units of the embodiment;

FIG. 5 is a fourth perspective view, showing the embodiment of FIG. 1, with the supplementary module replaced by an alternative functional unit;

FIG. 6 is a fifth perspective view, showing the embodiment of FIG. 1, with the supplementary module replaced by a place holder;

FIG. 7 is a sixth perspective view, showing the embodiment of FIG. 1, with the supplementary module replaced by another alternative functional unit; and

FIG. 8 is a perspective view of Creative Technology's Muvo media player.

### DETAILED DESCRIPTION OF PREFERRED EMBODIMENTS

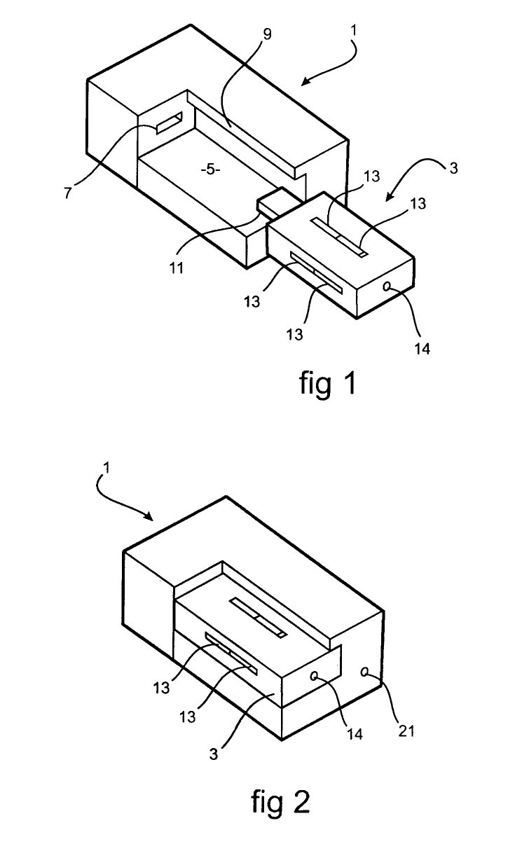

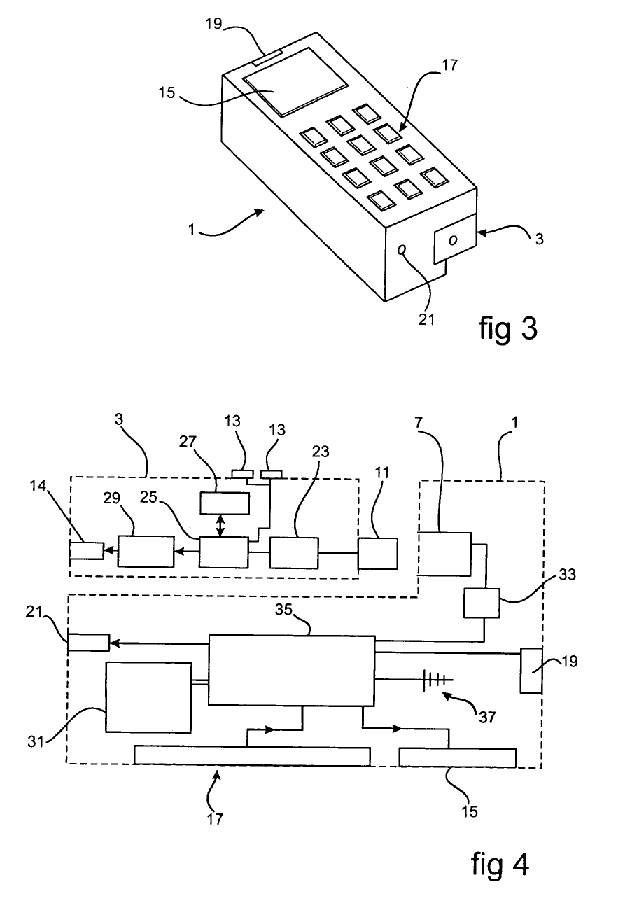

Referring to FIG. 1, an embodiment of the invention is shown composed of a mobile telephone unit 1 and an elongate supplementary module 3. In this embodiment, the supplementary module 3 may include a memory device and an MP3 decoder. The housing of the mobile telephone unit 1 includes a generally cuboidal cavity 5 in a corner location, for receiving the supplementary module 3. The cavity 5 includes a USB socket 7 at one end, and a lip 9 extending along the full length of the cavity 5 for acting as a cradle to the supplementary module 3. The supplementary module 3 is inserted along its long axis into the cavity 5 until a USB plug 11 at one end of its housing enters the USB socket 7. In FIG. 1, the embodiment is shown at a time just before the supplementary module 3 is inserted into the cavity 5, while in FIG. 2 the embodiment is shown in an “assembled configuration”, i.e. at a time when the USB plug 11 has been inserted into the USB socket 7, such that the mobile telephone unit 1 and the supplementary module 3 can fully communicate. FIG. 3 shows the embodiment in the assembled configuration from the direction which is beneath in FIG. 2. From this direction it can be seen that the mobile telephone unit 1 includes a screen 15 and an array 17 of keys. The housing of the mobile telephone unit 1 further includes a loudspeaker 19, and optionally a headphone socket 21. The screen 15 may be a LCD, LED or OLED display.

The supplementary module 3 has functional controls 13 of a known type to control playback of data stored in the module 3. The functional controls 13 may be for the manipulation of data playback from supplementary module 3, such as, for example, track skipping, content scanning, volume control and the like. The data may be audio and/or video and/or other stored data. The supplementary module further includes a headphone socket 14 for receiving a headphone plug.

As shown in FIGS. 1 to 2, the housing of the mobile telephone unit 1 is generally cuboidal (optionally, with rounding, especially at the corners), apart from the cavity 5. If a tight cuboidal hull were drawn around the mobile telephone unit 1, the cavity 5 would be within that hull. When the supplementary module 3 is inserted into the cavity 5, substantially all of it lies within this hull, so the overall volume of the mobile telephone unit 1—supplementary module combination is hardly increased as compared to that of the mobile telephone unit 1 alone (e.g. by only 10%, or less). The supplementary module 3 may include a USB socket for communication with additional USB memory storage devices. This may be to cope with increased memory requirements of the mobile telephone unit. The additional USB memory storage devices need not have built-in functional controls.

Referring to FIG. 4 a block diagram of the embodiment is shown. The supplementary module includes the USB plug 11, a USB controller 23, a decoder 25, a non-volatile solid-state memory device 27 (such as a flash memory device), an amplifier 29 and the headphone socket 14.

The mobile telephone unit 1 includes a USB socket 7, connected to a USB controller 33, for passing data backwards and forwards between the supplementary module 3 and a CPU 35 of the mobile telephone unit 1. The CPU 35 has the functionality of known mobile telephone units, and in particular is able to communicate wirelessly with an external communication network, such as the various forms of GSM or CDMA, using an antenna 37, by techniques which will not be described here. Manufacturers of the mobile telephone unit 1 keep the mobile telephone unit 1 at the forefront of mobile telephone technology by regularly producing new editions with the latest technologies and features to meet technological and faddish demands. This creates a renewable product that guards against obsolescence.

The CPU 35 is further able to receive commands from the array 17 of keys, and generate data to the screen 15. It is further operative to control a loudspeaker 19 and a headphone socket 21. The mobile telephone unit 1 is powered by a (usually rechargeable) battery module 31, which is shown connected to the CPU 35. More generally any components of the mobile telephone unit 1 may be electrically connected to the battery module 31 to draw power therefrom directly. In particular, the USB socket 7 is connected to the battery module 31 to transmit electrical power to the supplementary module 3 through the plug 11.

In an alternative embodiment, a touch/scroll pad like those found on Creative Technology Ltd's Zen Micro media player may be included on the housing of the mobile phone unit 1 rather than an array 17 of keys, where menus on the screen 15 enable the mobile telephone unit 1 to be used. A lens may also be incorporated onto the housing of the mobile telephone unit 1 which enables the capture of images by a digital camera circuit included in the housing of the mobile telephone unit 1. As such, moving or still images captured by the digital camera circuit are storable in the supplementary module 3.

When the supplementary module 3 is connected to the mobile telephone unit 1 it draws electrical power from the battery 31 of the mobile telephone unit 1 through the USB plug 11 to power its operation. This operation, which the user controls using the controls 13, may for example be for the decoder 25 to decompress audio data stored in the memory device 27 in a compressed form (e.g. MP3) using a decompression engine function of the decoder 25, and to transmit it, via the amplifier 29 (which is also controllable using the controls 13) to the headphone socket 14, so that the user can listen to it using a headphone device plugged into the socket 14. This mode of operation resembles a known mode of operation of a known memory module. Furthermore, as in a known system, the audio data stored in the memory device 27 may have been downloaded into the supplementary module 3 at a time when the supplementary module 3 was connected to a computer. As those skilled in the art will appreciate, a computer may include other computer system configurations, including hand-held devices, multiprocessor systems, microprocessor-based or programmable consumer electronics, minicomputers, and the like.

However, in contrast to the known use of the supplementary module 3, the supplementary module 3 has an interaction with the mobile telephone 1 which is not limited to receiving power from it. Instead, the supplementary module 3 is operative to interact with the mobile telephone 1 in any one of more of the following ways:

1. The mobile telephone unit 1 is operative to download data, such as MP3 files (e.g. received using from the communication network), into the supplementary module 3.

2. The mobile telephone unit 1 is operative to upload data from the supplementary module 3. This may for example be data for transmission to the communication network. Alternatively, or additionally, it may be audio/video data. For example, it may be uncompressed (e.g. analogue) audio data (which, optionally, the supplementary module 3 may generate by decompressing compressed files, e.g. on the fly), and the mobile telephone unit may be operative to regenerate the audio sound using the loudspeaker 19 and/or the headphone socket 21. In a further example, the data may be visual data, and the mobile telephone unit 1 may be operative to display images on the screen 15 using the visual data. The images may be moving images.

Optionally, the mobile telephone unit 1 may include a buffer memory (not shown). Using the buffer memory, for example, a file may be transferred from the supplementary module 3 to the mobile telephone unit 1 in its entirety before the mobile telephone unit 1 commences operation on the file (e.g. to transmit it out of the mobile telephone unit 1 via a communication network, or to transmit it to the user as audio sound). Accordingly, at the operation stage the mobile telephone unit does not have to be limited to the data transfer speed of the port 7. More generally, the mobile telephone unit 1 may control its operation and its interaction with the supplementary module 3 to ensure that the amount of buffered data stored in the buffer remains within an acceptable range: enough to ensure that the operation of the mobile telephone is not interrupted, and yet not enough to risk the buffer overflowing.

Although only a single supplementary module 3 is shown in FIG. 3, the embodiment may include multiple supplementary modules 3 (which may be supplied separately). In this way, the user of the mobile telephone 1 is able to obtain access to a different set of data and/or different supplementary module characteristics by replacing the supplementary module 3 which is presently attached to the mobile telephone unit 1 with another supplementary module.

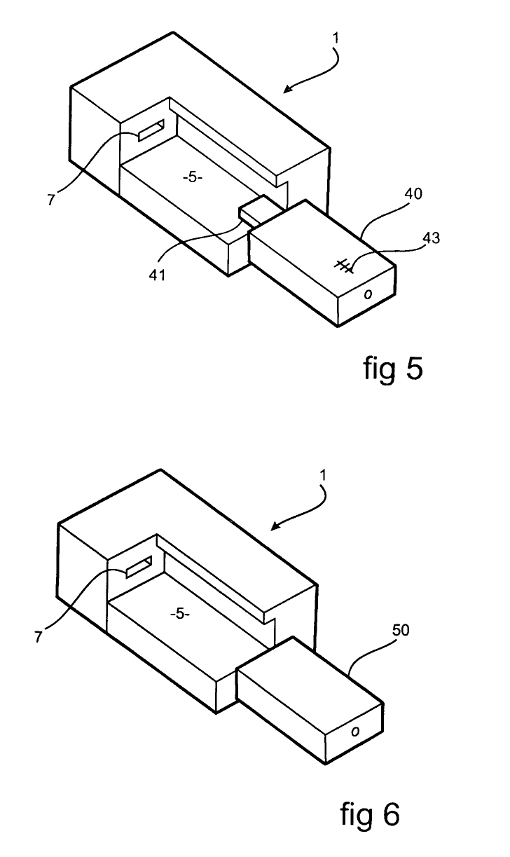

Furthermore, the embodiment may include another functional unit which is connectable to the mobile telephone 1 using the socket 7. This is illustrated in FIG. 5, where a functional module 40 is shown about to be slid into the cavity 5. The functional module 40 has a plug 41 for insertion into the socket 7. The functional module 40 may for example be a wi-fi module that is usable with the USB ports of existing computers, for communicating with wi-fi enabled devices, and in this case may have an antenna 43 (e.g. on its external housing or within the housing). Similar types of modules may be an AM/FM tuner module which allows the mobile telephone unit 1 to receive signals from radio stations' transmissions, and a Bluetooth dongle module to facilitate communication and file transfer with Bluetooth-enabled devices.

Furthermore, the embodiment may include a place holder 50 for insertion into the cavity 5 when neither a supplementary module 3 nor another functional unit 40 is in position, as shown in FIG. 6. This place holder 50 has the function of covering and protecting the socket 7, and giving the mobile telephone a more convex appearance. It should be noted that the mobile telephone unit 1 is able to function normally even when the place holder is coupled with the mobile telephone unit 1.

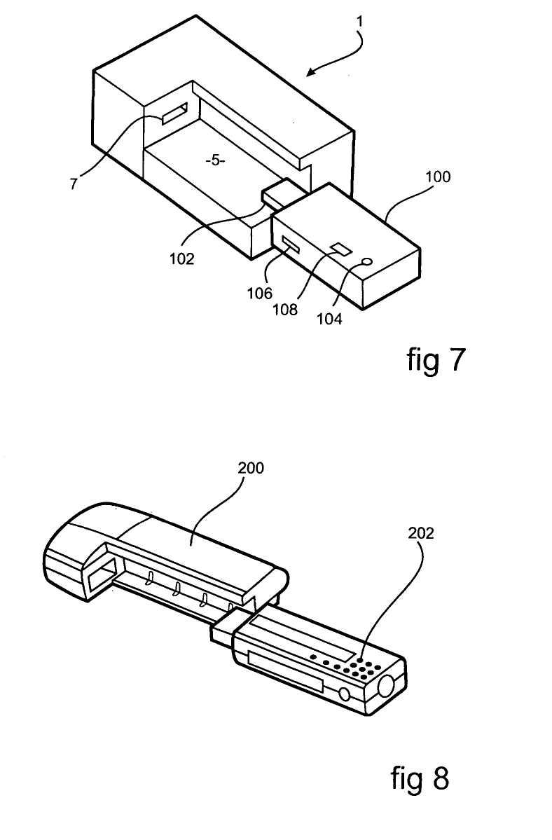

Another embodiment may include yet another functional unit which is connectable to the mobile telephone unit 1 using the socket 7. This is illustrated in FIG. 7, where a functional module 100 is shown about to be slid into the cavity 5. The functional module 100 has a plug 102 for insertion into the socket 7. The functional module 100 may for example be a digital camera module including a lens 104, trigger 106 and a flash 108 that is usable with the USB ports of existing computers. The functional module 100 may also include a non-volatile solid-state memory device 27 (such as a flash memory device) to store images captured by the module 100. Consequently, images stored in the module 100 may be viewed on the screen 15 of the mobile telephone unit 1.

In addition, the embodiment may include another alternative functional unit which is connectable to the mobile telephone unit 1 using the socket 7. This functional module is also able to be slid into the cavity 5 with a plug for insertion into the socket 7. This functional module may include a GPS transceiver that is able to send signals regarding the location of the mobile phone unit 1 via a GSM/EGSM network. This module is useful where the user of the mobile telephone unit 1 faces a risk of getting lost in an environment where coverage of the GSM/EGSM network is not comprehensive.

Although only a single embodiment of the invention has been described here in detail, many variations are possible within the scope of the invention which is defined by the claims. For example, it is to be understood that although in the embodiment above the plug 11 and socket 7 are a USB plug and socket respectively, the invention is not limited in this respect, and other ports are also possible within the scope of the invention. For example, the port 11 may alternatively be a IEEE1394 plug and the port 7 may alternatively be a IEEE1394 socket. Furthermore, optionally, it may be the plug, rather than the socket, which is provided on the mobile telephone unit 1, although this option is not presently preferred.

1. A mobile telephone unit including:
a first data transfer port; and
a supplementary module having:
(i) a second data transfer port;
(ii) a non-volatile memory for storing compressed media data; and
(ii) a decoder programmed to decompress the compressed media data;
wherein the first data transfer port is able to be coupled to the second data transfer port for data communication.

2. The mobile telephone unit of claim 1, wherein the supplementary module includes controls to manipulate playback of media data stored in the supplementary module.

3. The mobile telephone unit of claim 1, further including a mechanical support for mounting the supplementary module detachably on the mobile telephone unit with the respective data transfer ports coupled to each other for data communication.

4. The mobile telephone unit of claim 1, wherein the mobile telephone unit is configured to receive data from a communication network and transfer it to the first data transfer port, and the decoder of the supplementary module is arranged to receive data from the mobile telephone unit via the first and second data transfer ports and store it in the non-volatile memory.

5. The mobile telephone unit of claim 1, wherein the decoder of the supplementary module is arranged to receive data from the non-volatile memory, and pass it to the second data transfer port, the mobile telephone unit being arranged to receive the data from the second transfer port and transmit it wirelessly to a communication network.

6. The mobile telephone unit of claim 1, wherein the decoder of the supplementary module is arranged to decompress compressed audio data in the non-volatile memory and pass the decompressed data to the second data transfer port, the mobile telephone being arranged to receive the decompressed data and generate audio sound from it.

7. The mobile telephone unit of claim 1, wherein the supplementary module includes a further data transfer port for transferring data.

8. The mobile telephone unit of claim 7, wherein the further data transfer port is a socket for a headphone unit.

9. The mobile telephone unit of claim 1, wherein the supplementary module is arranged to be powered by electrical power received from the mobile telephone unit via and first and second data transfer ports.

10. The mobile telephone unit of claim 3 further including an additional supplementary module including:
a third data transfer port,
a non-volatile memory for storing compressed media data, and
a decoder programmed to decompress the compressed media data;
the additional supplementary module being shaped for mounting to mobile telephone unit using the mechanical support, with the third data transfer port coupled to the first data transfer port for data communication.

11. The mobile telephone unit of claim 10, wherein the additional supplementary module includes controls to manipulate playback of media data stored in the supplementary module.

12. The mobile telephone unit of claim 3 further including a wireless communication module including:
a fourth data transfer port;
a processor; and
an antenna controllable by the processor to establish wireless communication with further wireless communication devices;
the wireless communication module being shaped for mounting to mobile telephone unit using the mechanical support, with the fourth data transfer port coupled to the first data transfer port for data communication.

13. The mobile telephone unit of claim 1, wherein the wireless communication protocols are selected from the group comprising: Wi-Fi, Bluetooth, and AM/FM signals.

14. The mobile telephone unit of claim 3, wherein the mobile telephone unit includes a housing defining a cavity for receiving the supplementary module, the mechanical support comprising one of more elements for supporting the supplementary module within the cavity.

15. The mobile telephone unit according to claim 14, wherein, when the supplementary module is received within the cavity, the combination of the supplementary module and mobile telephone unit has a generally cuboidal configuration.

16. The mobile telephone unit according to claim 1, further including a touch/scroll pad to control functionalities of the telephone unit.

17. The mobile telephone unit of claim 3 further including an additional supplementary module including:
a fifth data transfer port;
a lens to focus light; and
a digital camera circuit to capture images focussed through the lens;
the additional module being shaped for mounting to the mobile telephone unit using the mechanical support, with the fifth data transfer port coupled to the first data transfer port for data communication.

18. The mobile telephone unit of claim 3 further including an additional supplementary module including:
a sixth data transfer port; and
a GPS transceiver;
the additional module being shaped for mounting to the mobile telephone unit using the mechanical support, with the sixth data transfer port coupled to the first data transfer port for data communication to enable the sending of signals regarding the location of the mobile phone unit via a GSM/EGSM network.

19. A supplementary module including:
a data transfer port;
a non-volatile memory for storing compressed media data; and
a decoder programmed to decompress the compressed media data,
wherein the supplementary module is connectable to a mobile telephone unit.

20. The supplementary module of claim 1, wherein the mobile telephone unit includes a mechanical support for mounting the supplementary module detachably on the mobile telephone unit with the data transfer ports coupled to a socket on the mobile telephone unit for data communication.
